(19) United States
(12) Patent Application Publication
(10) Pub. No.: US 2023/0077800 A1
(43) Pub. Date: Mar. 16, 2023

(54) AUGMENTED REALITY TRANSPORTATION SYSTEMS

(71) Applicant: AT&T Intellectual Property I, L.P., Atlanta, GA (US)

(72) Inventors: Walter Cooper Chastain, Atlanta, GA (US); Barrett Kreiner, Woodstock, GA (US); James Pratt, Round Rock, TX (US); Adrianne Binh Luu, Atlanta, GA (US); Robert T. Moton, JR., Alpharetta, GA (US); Ari Craine, Marietta, GA (US); Robert Koch, Peachtree Corners, GA (US)

(21) Appl. No.: 17/473,327

(22) Filed: Sep. 13, 2021

(51) Int. Cl. G06Q 10/02; G06F 3/01; G07C 9/28; G07C 9/22; G07C 9/10; G06Q 30/02; G06T 19/00

(52) U.S. Cl. CPC G06Q 10/02; G06F 3/011; G07C 9/28; G07C 9/22; G07C 9/10; G06Q 30/0283; G06T 19/006

(57) ABSTRACT

A processing system may obtain traveler data comprising location data of devices of a plurality of travelers, the travelers having reservations to travel aboard a vehicle of a transportation service provider from a point of departure at a designated time of readiness and obtain timing data of a queue from a service provider system associated with the queue, where at least one traveler of the travelers is to traverse the queue to arrive at the point of departure. The processing system may then calculate arrival times of the travelers based upon the traveler data and based upon the timing data of the queue, determine that an arrival time of the at least one traveler is after the designated time of readiness, and perform at least one remedial action in response to the determining that the arrival time of the at least one traveler is after the designated time of readiness.

The present disclosure relates generally to transportation service provider applications and systems (e.g., transportation management systems, fleet management systems, or the like) and more particularly to methods, computer-readable media, and apparatuses for performing at least one remedial action in response to determining that an arrival time of at least one of a plurality of travelers is after a designated time of readiness for traveling aboard a vehicle in accordance with location data of devices of the plurality of travelers and timing data of at least one queue and to methods, computer-readable media, and apparatuses for obtaining and presenting a digital token to at least one service provider system associated with at least one queue to obtain a prioritized transit of the at least one queue.

### BACKGROUND

Various travel and transportation applications (apps) provide users with the ability to browse and book/reserve flights, cruises, train voyages, and so forth. An airline may provide an airline app via which a user may reserve a one way or round-trip flight. In addition, the airline app may enable the downloading of an e-ticket, which can be presented on a screen of a mobile device to be used to check-in and to board a flight.

### SUMMARY

In one example, the present disclosure describes a method, non-transitory computer-readable medium, and apparatus for performing at least one remedial action in response to determining that an arrival time of at least one traveler of a plurality of travelers is after a designated time of readiness for traveling aboard a vehicle in accordance with location data of devices of the plurality of travelers and timing data of at least one queue. For instance, in one example, a processing system including at least one processor may obtain traveler data comprising at least location data of a plurality of devices of a plurality of travelers, the plurality of travelers having reservations to travel aboard a vehicle of a transportation service provider from a point of departure at a designated time of readiness. The processing system may also obtain timing data of at least one queue from at least one service provider system associated with the at least one queue, wherein at least one traveler of the plurality of travelers is to traverse the at least one queue to arrive at the point of departure. The processing system may then calculate arrival times of the plurality of travelers based upon the traveler data comprising at least the location data of the plurality of devices of the plurality of travelers and based upon the timing data of the at least one queue, determine that an arrival time of at least one traveler of the plurality of travelers is after the designated time of readiness, and perform at least one remedial action in response to the determining that the arrival time of the at least one traveler of the plurality of travelers is after the designated time of readiness.

In another example, the present disclosure describes an apparatus, non-transitory computer-readable medium, and method for obtaining and presenting a digital token to at least one service provider system of a transportation service provider associated with at least one queue to obtain a prioritized transit of the at least one queue. For instance, in one example, a processing system including at least one processor may provide location data of the apparatus to a transportation service provider system, where the apparatus is associated with a traveler having a reservation to travel aboard a vehicle of the transportation service provider from a point of departure at a designated time of readiness, where the traveler is to traverse the at least one queue to arrive at the point of departure, obtain an alert from the transportation service provider system indicating that the traveler is anticipated to not be at the point of departure at the designated time of readiness, and present the alert to the traveler. The processing system may also obtain a digital token from the transportation service provider system, wherein the digital token is presentable via the apparatus to obtain a prioritized transit of the at least one queue for the traveler and present the digital token to at least one service provider system associated with the at least one queue to obtain the prioritized transit of the at least one queue for the traveler.

### BRIEF DESCRIPTION OF THE DRAWINGS

The teachings of the present disclosure can be readily understood by considering the following detailed description in conjunction with the accompanying drawings, in which:

FIG. 1 illustrates an example system comprising one or more communication networks related to the present disclosure;

FIG. 2 illustrates an example interface for presenting traveler information to an agent of transportation carrier, in accordance with the present disclosure;

FIG. 3 illustrates an example interface that may be provided to assist a traveler in reaching a point of departure, in accordance with the present disclosure;

FIG. 4 illustrates a flowchart of an example method for performing at least one remedial action in response to determining that an arrival time of at least one of a plurality of travelers is after a designated time of readiness for traveling aboard a vehicle in accordance with location data of devices of the plurality of travelers and timing data of at least one queue;

FIG. 5 illustrates a flowchart of an example method for obtaining and presenting a digital token to at least one service provider system associated with at least one queue to obtain a prioritized transit of the at least one queue; and

FIG. 6 illustrates a high level block diagram of a computing device specifically programmed to perform the steps, functions, blocks and/or operations described herein.

To facilitate understanding, identical reference numerals have been used, where possible, to designate identical elements that are common to the figures.

### DETAILED DESCRIPTION

Examples of the present disclosure enable more efficient and precise scheduling of transportation systems where multiple passengers are using a common vehicle. In particular, examples of the present disclosure track travelers as they are arriving at a point of departure for a shared vehicle, such as an airplane. By sharing location and other data with the transportation carrier, travelers can better manage their own timings to reach the departure point on time, while the transportation carrier may better control boarding logistics, departure schedules, and other aspects of operating a transportation system.

In one example, a traveler may be equipped with a mobile computing device such as a smart phone. The device may be equipped with a transportation carrier application (app) that may be in communication with a transportation carrier server. The traveler may optionally also have a wearable biometric monitoring device, and also be equipped with speakers such as earbuds that may be in communication with the mobile computing device. The traveler may alternatively or additionally be equipped with an augmented reality (AR) viewer such as AR glasses (which may be a standalone computing device, or which may be a peripheral in communication with the traveler's mobile computing device) or an AR app on the mobile computing device. The transportation carrier server may have access to a traveler database and also a scheduling database that maintains and manages schedules for various vehicles of the transportation carrier. In one example, the transportation carrier server may be in communication with a communication device of a vehicle manager, such as a gate agent at an airport, who may manage a specific vehicle (e.g., including managing the departure of the vehicle and its passengers). In particular, examples of the present disclosure may track multiple travelers to improve the transportation carrier's ability to manage a particular trip/voyage of a vehicle (and similarly for other vehicles and other trips offered by the transportation carrier). It should be noted that although examples herein are described primarily in connection with travelers taking a flight, examples of the present disclosure are equally applicable to other modes of passenger transportation, including voyages by sea or rail, bus trips, and so forth.

In one example, a traveler may elect to share data describing the traveler's physical situation with the transportation carrier via an app on a mobile computing device of the traveler, and which may be sent to the transportation carrier server periodically or on another basis. This data, e.g., “traveler data” may include one or more of: a current location, a current speed, a current direction of movement, and/or a current mode of transportation of a traveler, physical density (e.g., of other persons near the traveler), biometric data of the traveler, such as heart rate/pulse, breathing rate, etc., and so on. In one example, the app may be configured so that this data is only shared with the transportation carrier server on days or during timeframes when the traveler has a reservation with the carrier. In an example where a traveler elects to share biometric data, the biometric data may be obtained from a biometric component of a mobile computing device of the traveler, or may be obtained from a biometric device that is paired with the mobile computing device via a near-field connection, such as IEEE 802.15 based communications (e.g., Bluetooth or the like). Similarly, in an example in which physical density data may be provided, for instance, a measure of how crowded the traveler's environment is, such data may be obtained by a sonar signal(s), light detection and ranging (LIDAR) signal(s), image data from the locations (e.g., cameras situated in the surrounding areas of the user) or the like, which may be emanated by the mobile computing device.

Any or all of such traveler data describing a traveler's physical situation may be stored in a traveler database in a record associated with the traveler, which may be updated on an ongoing basis, e.g., with each refresh of data sent from the traveler's mobile computing device. By having access to the traveler data, a vehicle manager, such as a gate agent, may have access to a display that presents a visual indication of where the traveler is at the moment (and similarly for other travelers of a same flight). Further, the transportation carrier server may also present other data that is received and/or may determine to offer additional informative data to the agent. For example, the transportation carrier server may receive an estimated wait time at a security checkpoint from an airport computing system or from a computing system of a security service provider. The transportation carrier server may then calculate an estimated time of arrival (ETA) at the gate for the traveler based on the traveler's current location, the wait time at the security checkpoint, an expected time for the traveler to walk to the gate, which may be calculated based on the traveler's recent walking speed(s) and the distance to the gate from the traveler's current (or most recently available) location. The traveler's gate estimated time of arrival (ETA) may be included in the traveler database record of the traveler.

Similarly, the traveler may be waiting to pick up a coffee order from a coffee shop in the airport terminal. For example if the traveler orders a coffee using a mobile app, a computing system of the coffee shop (e.g., comprising an ordering system, an inventory system, and so forth) may make an estimate as to what time the coffee will be available for the traveler to pick up. The coffee shop ordering system may communicate this wait time with the traveler's app, which may then send it to the transportation carrier server. Alternatively, or in addition, the coffee shop's ordering system may be in communication with the transportation carrier server. In this manner, the expected wait time for the coffee may be incorporated into the ETA estimate calculated by the transportation carrier server for gate arrival for the traveler.

For illustrative purposes, it may be assumed that the traveler is predicted to be running late. In one example, the vehicle manager, e.g., the gate agent may be notified by the transportation carrier server via the display, and may also be presented with an option to send a message to the traveler. For instance, a message may be sent by the transportation carrier server to the traveler's mobile computing device, where the message may be presented as an alert. In another example, this alert may be sent by the transportation carrier server (e.g., via an automated system) without requiring an action from the agent. Alternatively, or in addition, the transportation carrier server may initiate a two-way conversation between the traveler and the agent via their respective devices. In one example, the transportation carrier server may send a request to the coffee shop's computing system to change the customers' positions in queue to make the late traveler's purchase order a higher priority, thereby expediting the traveler's completion of the purchase.

The traveler may also interact, for instance via a speech interface, with the app to execute a status query. For instance, the traveler may ask the transportation carrier server if the traveler is anticipated to be on time (or running late) for arriving at the gate on or before the designated time. The transportation carrier server may respond by comparing the traveler's ETA with the designated time (e.g., the scheduled boarding time for the plane, the scheduled boarding time for the traveler's zone on the plane, etc.). Alternatively, or in addition, since the transportation carrier server may have access to other computing systems, such as the coffee shop's computing system or purchase ordering system, the traveler may execute a query such as: “Do I have time to get a coffee here?” The transportation carrier server may parse and interpret the query using speech recognition and natural language processing techniques to determine the traveler's intent. The transportation carrier server may access estimated wait time data either from the coffee shop's computing system and/or via communication between the transportation carrier app and an app for the coffee shop on the mobile computing device of the traveler. The transportation carrier server may use the estimated wait time and the current ETA to determine if a delayed ETA would still be on time, and may respond to the traveler accordingly.

If the traveler is within the airport, AR anchors may be employed to enable pacesetting AR display(s) to be presented to the traveler on the way to the gate. For example, the transportation carrier server may receive the traveler's location data, and may therefore determine the distance to the gate, the traveler's speed, and so forth. The transportation carrier server may also take into account factors such as the expected time when the traveler will be called for boarding. For instance, this may be estimated by the server using the traveler's seat/zone from the traveler database, which may contain data related to the traveler's reservation. The transportation carrier server may also calculate an estimated time when the traveler's zone will be called for boarding based on how many passengers have already been scanned for boarding by the gate agent and the current scheduled departure time from a schedule database.

Having calculated when the traveler is estimated to be called for boarding and knowing the traveler's current location, the transportation carrier server may determine an average pace the traveler must maintain to stay on time. Knowing the traveler's location, the server may send AR display data to the traveler's mobile computing device, which may comprise an AR viewing device or which may be paired with an AR viewing device. The AR display data may include an indication of a nearby known AR anchor point to use for the AR display. In one example, the AR display data may include a countdown timer specific to an AR anchor location and/or other visual information that may help the traveler know what walking pace to set to reach the gate on time. In one example, the AR display data may also include directions (e.g., using arrows, visual beacons, or the like) to assist the traveler in navigating from a current location to the departure gate. Optionally, audio instructions may also be presented to the traveler to indicate, for instance, if the traveler need to speed up their pace, and similarly to provide directions to navigate from a current location to the departure gate, e.g., “proceed 300 feet straight ahead,” “turn right at the end of the corridor,” etc.

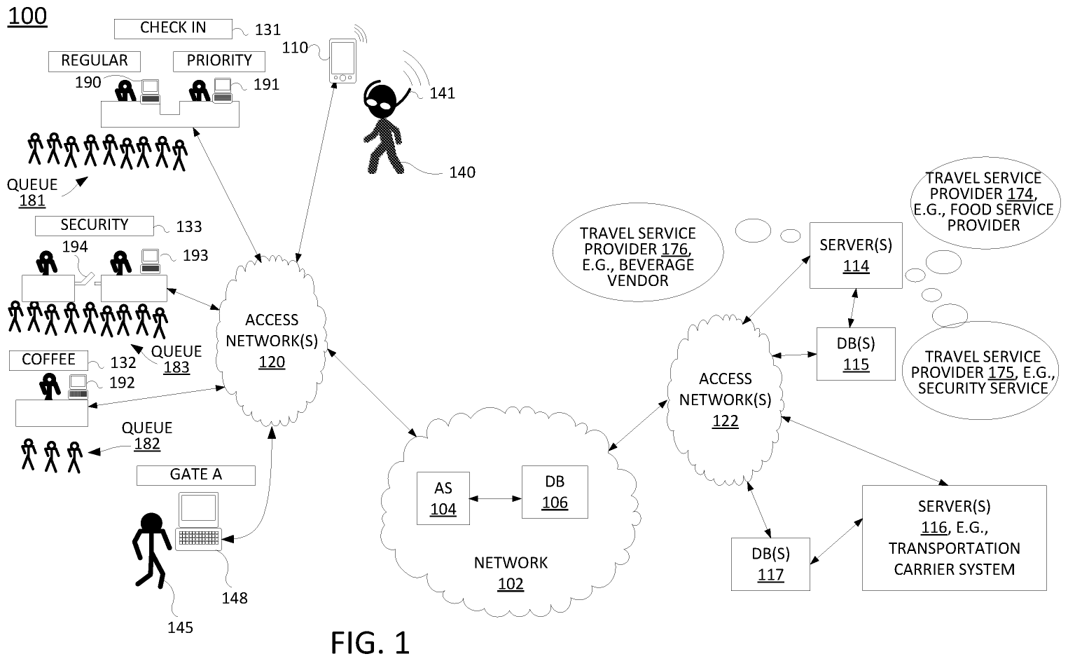

The transportation carrier server may similarly track multiple travelers, all destined for the same vehicle for departure. Each traveler's ETA may be calculated and stored in the traveler database. In one example, the collective data (and/or the individual data) from all or a portion of the travelers may be presented to the gate agent via a display of a computing device of the gate agent. Additionally, the transportation carrier server may access data from the schedule database to determine how much flexibility is available to adjust a departure time to be earlier or later than the current schedule. If, for instance, the latest ETA at the gate for a particular traveler is 10 minutes late, and if the schedule flexibility permits a departure delay of 10 minutes or more, the transportation carrier server may make a time change of 10 minutes and record it in the schedule database. In one example, the transportation carrier server may also transmit a notification of the change to the travelers having reservations for the current flight (e.g., including the late traveler) and to the gate agent, to flight personnel, and so on. These and other aspects of the present disclosure are described in greater detail below in connection with the examples of FIGS. 1-6.

To further aid in understanding the present disclosure, FIG. 1 illustrates an example system 100 in which examples of the present disclosure may operate. The system 100 may include any one or more types of communication networks, such as a traditional circuit switched network (e.g., a public switched telephone network (PSTN)) or a packet network such as an Internet Protocol (IP) network (e.g., an IP Multimedia Subsystem (IMS) network), an asynchronous transfer mode (ATM) network, a wireless network, a cellular network (e.g., 2G, 3G, 4G, 5G and the like), a long term evolution (LTE) network, and the like, related to the current disclosure. It should be noted that an IP network is broadly defined as a network that uses Internet Protocol to exchange data packets. Additional example IP networks include Voice over IP (VoIP) networks, Service over IP (SoIP) networks, and the like.

In one example, the system 100 may comprise a network 102 (e.g., a telecommunication network of a telecommunication service provider). The network 102 may be in communication with one or more access networks 120 and 122, and the Internet (not shown). In one example, network 102 may combine core network components of a cellular network with components of a triple play service network; where triple-play services include telephone services, Internet services and television services to subscribers. For example, network 102 may functionally comprise a fixed mobile convergence (FMC) network, e.g., an IP Multimedia Subsystem (IMS) network. In addition, network 102 may functionally comprise a telephony network, e.g., an Internet Protocol/Multi-Protocol Label Switching (IP/MPLS) backbone network utilizing Session Initiation Protocol (SIP) for circuit-switched and Voice over Internet Protocol (VoIP) telephony services. Network 102 may further comprise a broadcast television network, e.g., a traditional cable provider network or an Internet Protocol Television (IPTV) network, as well as an Internet Service Provider (ISP) network. In one example, network 102 may include a plurality of television (TV) servers (e.g., a broadcast server, a cable head-end), a plurality of content servers, an advertising server (AS), an interactive TV/video-on-demand (VoD) server, and so forth. For ease of illustration, various additional elements of network 102 are omitted from FIG. 1.

In one example, the access networks 120 and 122 may comprise Digital Subscriber Line (DSL) networks, public switched telephone network (PSTN) access networks, broadband cable access networks, Local Area Networks (LANs), wireless access networks (e.g., an Institute of Electrical and Electronics Engineers (IEEE) 802.11/Wi-Fi network and the like), cellular access networks, 3^{rd} party networks, and the like. For example, the operator of network 102 may provide a broadband Internet access service, or any other types of telecommunication service to subscribers via access networks 120 and 122. In one example, the access networks 120 and 122 may comprise different types of access networks, may comprise the same type of access network, or some access networks may be the same type of access network and other may be different types of access networks. In one example, the network 102 may be operated by a telecommunication network service provider. The network 102 and the access networks 120 and 122 may be operated by different service providers, the same service provider or a combination thereof, or may be operated by entities having core businesses that are not related to telecommunications services, e.g., corporate, governmental, or educational institution LANs, and the like.

In one example, the access networks 120 may be in communication with one or more devices, e.g., devices 110, 141, 148, and 190-194. Similarly, access networks 122 may be in communication with one or more devices, e.g., servers 114 and 116, DB(s) 115 and 117, etc. Access networks 120 and 122 may transmit and receive communications between devices 110, 141, 148, and 190-194, servers 114, servers 116, DB(s) 115 and 117, application server (AS) 104, database (DB) 106, and/or other components of network 102, devices reachable via the Internet in general, and so forth. In one example, device 110 may comprise any single device or combination of devices that may comprise an endpoint device, e.g., a client device or user device. For example, device 110 may comprise a mobile computing device, e.g., a cellular smart phone, a laptop, a tablet computer, or the like. Similarly, in one example, device 141 may comprise any single device or combination of devices that may comprise an endpoint device, e.g., a client device or user device. In one example, traveler 140 may be equipped with either or both of devices 110 and 141. In one example, device 141 may comprise an AR viewer, e.g., smart glasses or smart goggles, that is paired with device 110 (e.g., where device 141 does not independently communicate with other devices). In another example, device 141 may comprise a standalone mobile computing device.

In one example, device 110 and/or device 141 may have one or more applications installed thereon, such as a transportation carrier app to interact with a transportation carrier system (e.g., one or more of servers 116), a beverage vendor app (e.g., for browsing menus, placing orders with various locations of a beverage vendor, etc.), and so on. In general, user 140 may have interactions with a plurality of different travel service providers, some or all of which may have an associated application that is also installed and available on the device 110 and/or device 141, such as travel service provider 174, which may comprise a restaurant, a restaurant chain, or the like (e.g., a food service provider), travel service provider 175, which may comprise a security service (e.g., a governmental or quasi-governmental agency, such as the Transportation Security Administration (TSA), Amtrak Police, Port Authority Police, or the like), a private security service (for instance additional security provided by an airport operator, train station operator, or a contractor on behalf of such entities, on behalf of an airline, rail carrier, etc., and so on), travel service provider 176 (e.g., a beverage vendor, such as a coffee shop, coffee shop chain, or the like), and so forth. It should be noted that these are just several examples of various travel service providers and that such categories are provided for illustrative purposes only. For instance, a beverage vendor may also comprise a food service provider (e.g., a fast food chain that also offers coffee, tea, soda, or other beverages). In one example, device 110 and/or device 141 may include one or more radio frequency (RF) transceivers (as well as antenna(s), and/or other components) for cellular communications and/or for non-cellular wireless communications, such as for IEEE 802.11 based communications, IEEE 802.15 based communications, and so forth.

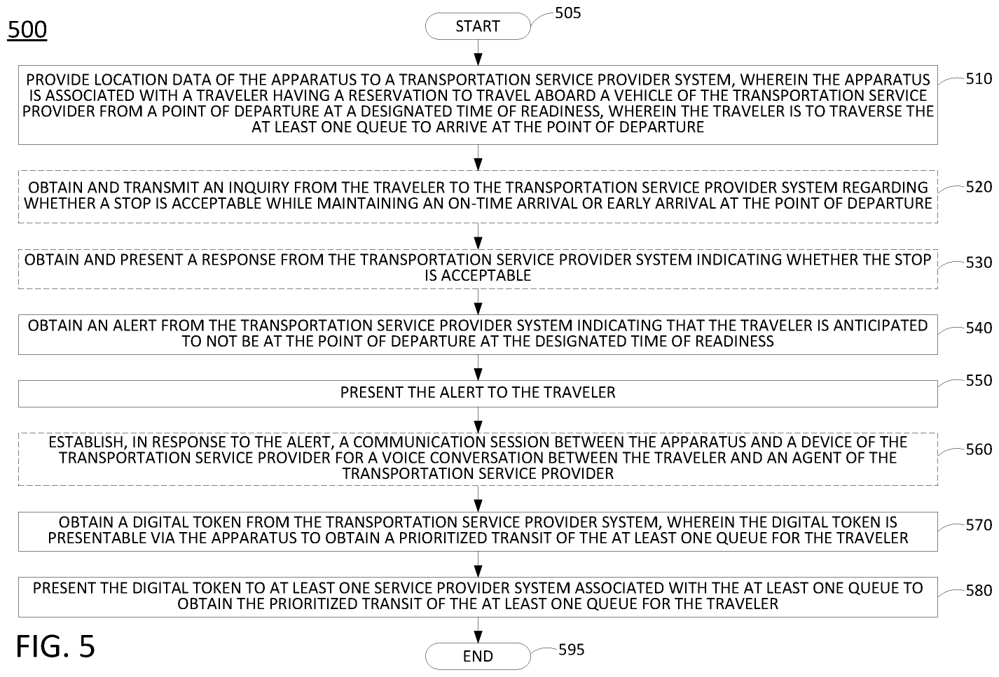

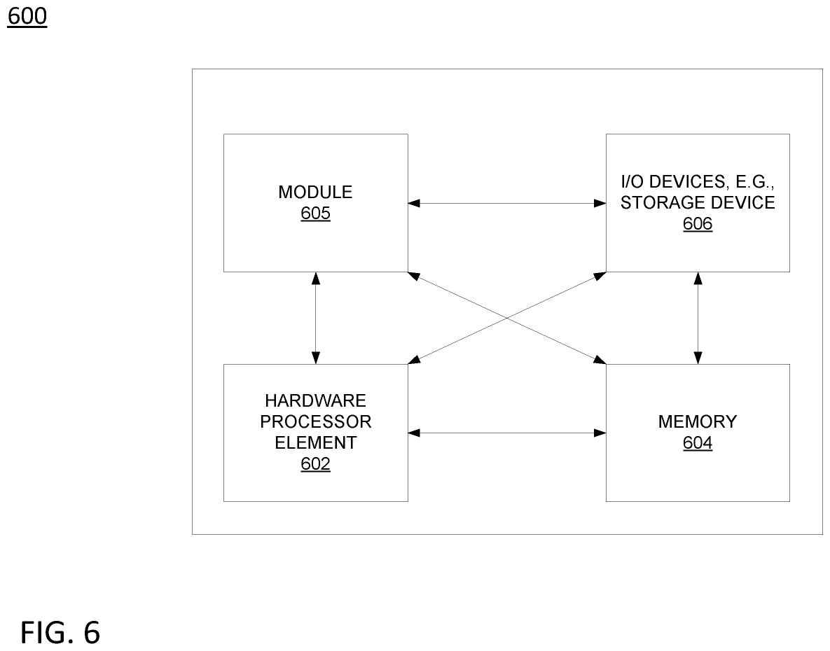

In one example, device 110 and/or device 141 may comprise a computing device or processing system, such as computing system 600 depicted in FIG. 6, and may be configured to provide one or more operations or functions in connection with examples of the present disclosure for obtaining and presenting a digital token to at least one service provider system associated with at least one queue to obtain a prioritized transit of the at least one queue. A flowchart of an example method 500 for obtaining and presenting a digital token to at least one service provider system associated with at least one queue to obtain a prioritized transit of the at least one queue is illustrated in FIG. 5 and discussed in greater detail below.

In addition, it should be noted that as used herein, the terms “configure,” and “reconfigure” may refer to programming or loading a processing system with computer-readable/computer-executable instructions, code, and/or programs, e.g., in a distributed or non-distributed memory, which when executed by a processor, or processors, of the processing system within a same device or within distributed devices, may cause the processing system to perform various functions. Such terms may also encompass providing variables, data values, tables, objects, or other data structures or the like which may cause a processing system executing computer-readable instructions, code, and/or programs to function differently depending upon the values of the variables or other data structures that are provided. As referred to herein a “processing system” may comprise a computing device, or computing system, including one or more processors, or cores (e.g., as illustrated in FIG. 6 and discussed below) or multiple computing devices collectively configured to perform various steps, functions, and/or operations in accordance with the present disclosure.

Similarly, server(s) 114 may each comprise a computing system or server, such as computing system 600 depicted in FIG. 6, and may be configured to perform operations in connection with examples of the present disclosure for performing at least one remedial action in response to determining that an arrival time of at least one of a plurality of travelers is after a designated time of readiness for traveling aboard a vehicle in accordance with location data of devices of the plurality of travelers and timing data of at least one queue and/or for obtaining and presenting a digital token to at least one service provider system associated with at least one queue to obtain a prioritized transit of the at least one queue. For instance, server(s) 114 may comprise server-side program, logic, instructions, data and so forth for travel service provider applications associated with travel service providers 174-176. In one example, database(s) 115 may represent a plurality of different distributed file systems, e.g., a Hadoop® Distributed File System (HDFS™), or the like associated with each of the travel service providers 174-176. Server(s) 114 may receive and store information in database(s) 115 relating to different travelers, such as traveler 140 (although only one traveler, or “user,” is illustrated in FIG. 1, it should be understood that this traveler can be representative of multiple travelers), and with respect to the different travel services via respective travel service provider apps installed on travelers' device or via on-premises devices of the travel service providers (such as devices 192 and 193). For instance, traveler 140 may register with and opt-in to use apps associated with travel service providers 174-176, e.g., via server(s) 114. In one example, server(s) 114 may establish communications with user/traveler devices, such as device 110 periodically or on another basis to obtain and update all or a subset of the information maintained in database(s) 115 relating to users of the respective travel service provider apps (e.g., travelers).

Database(s) 115 may also store information relating to the respective operations of travel service providers 174-176. For instance, travel service provider 175, e.g., a security service, or security service provider, may operate a security checkpoint 133 at an airport. It should be noted that the security service may also operate additional security checkpoints at the same airport, at multiple airports and/or other transit venues, and so on, all of which may have associated data stored in DB(s) 115. In the example of FIG. 1, security checkpoint 133 may include devices 193 and 194, either or both of which may be in communication with an associated one or more of server(s) 114 (e.g., a computing system of travel service provider 175). Device 193 may comprise a computing device used by one or more agents of the security service, e.g., for, among other things, managing a queue 183 of travelers (e.g., a security line at the security checkpoint 133). Device 194 may comprise, for example, an automated turnstile or gate. For instance, mobile devices or radio frequency identification (RFID) cards, badges, or the like that may present valid digital tokens to cause the device 194 to open, activate, or otherwise allow access. For example, device 194 may permit bypassing all or a portion of queue 183, e.g., thereby allowing faster access to a security agent, x-ray or other scanners for travelers and/or baggage, and so forth.

As further illustrated in FIG. 1, travel service provider 176, e.g., a beverage vendor, may operate a coffee shop 132 at the airport. It should be noted that the beverage vendor may also operate additional coffee shops at the same airport, at multiple airports and/or other transit venues, and so on, all of which may have associated data stored in DB(s) 115. In the example of FIG. 1, coffee shop 132 may include device 192, which may be in communication with an associated one or more of server(s) 114 (e.g., a computing system of travel service provider 176). Device 192 may comprise a computing device used by one or more personnel of the beverage vendor, e.g., for recording orders, accepting payment, tracking fulfillment of orders, and so on. Thus, for instance, device 192 may maintain a list of pending orders waiting to be fulfilled. In other words, queue 182 may comprise travelers (or other customers) waiting for orders to be fulfilled according to a list that may be maintained by device 192. It should be noted that although a single device 192 is illustrated in FIG. 1, the device 192 may represent multiple devices comprising an on-premises computing system, such as one or more point-of-sale terminals, display screen(s) for one or more personnel fulfilling orders, and so on. It should again be noted that device 192 may be in communication with one or more server(s) 114, which may further coordinate in maintaining order lists/queues at one or more premises of the beverage vendor, may send instructions for changing priority of orders, and so forth, as discussed in greater detail below. It should be noted that travel service provider 174 (e.g., a food service provider) may have a similar location within the airport, which is omitted from FIG. 1 for ease of illustration. Thus, it should be understood that there may be one or more food service locations within the airport, with respective devices for obtaining orders, maintaining a queue/list of pending orders, managing table reservations and/or availability, and so on, which may be in communication with respective one or more of server(s) 114, and which may store associated data within DB(s) 115.

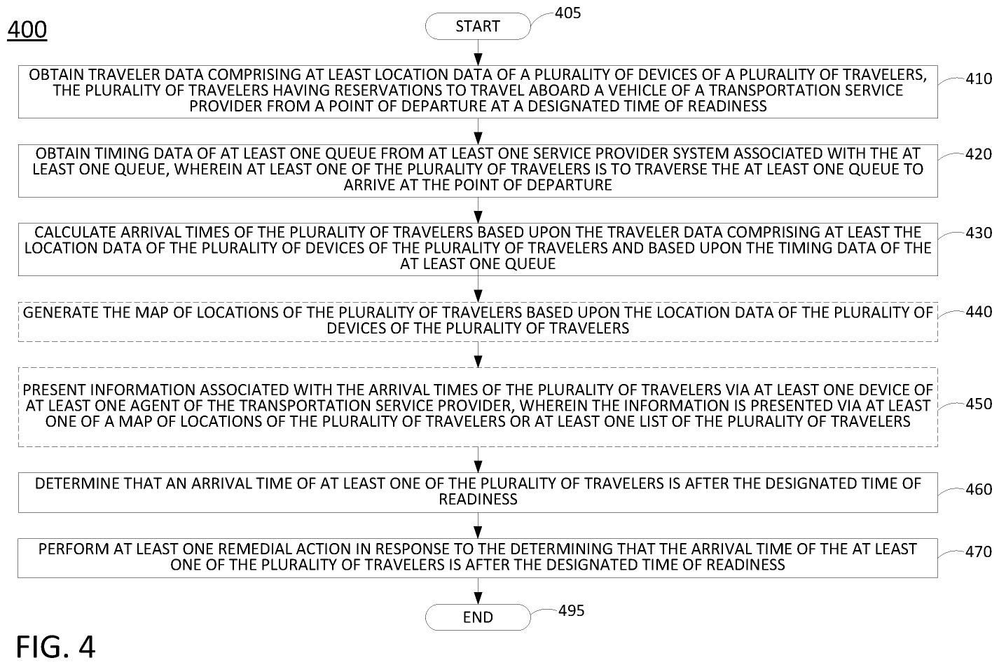

As illustrated in FIG. 1, one or more servers 116 may each comprise a computing system or server, such as computing system 600 depicted in FIG. 6, and may be configured to perform operations for performing at least one remedial action in response to determining that an arrival time of at least one of a plurality of travelers is after a designated time of readiness for traveling aboard a vehicle in accordance with location data of devices of the plurality of travelers and timing data of at least one queue, e.g., as described in connection with FIG. 4. For instance, server(s) 116 may comprise a transportation carrier server/system comprising server-side program, logic, instructions, data and so forth for a transit service provider application.

In one example, database(s) 117 may represent distributed or centralized file systems, e.g., a HDFS™, or the like associated with the cross-service broker app. For instance, server(s) 116 may receive and store information in database(s) 117 information regarding flight/aircraft statuses, schedules, information relating to whether the aircraft is on-schedule or delayed, e.g., a current location, fuel status, aircraft amenities (e.g., seating arrangements, WIFI connectivity, entertainment options, and so on), etc. For instance, one or more of server(s) 116 in conjunction with one or more of DB(s) 117 may comprise a suite of airline management systems, e.g., an airline reservation and booking system, an airline flight management system, etc. In addition, server(s) 116 may receive and store information in database(s) 117 relating to different travelers, such as traveler 140, and with respect to the different travel services. For example, server(s) 116 may store and update a travel itinerary for a trip of traveler 140, may store permissions of traveler 140 to interact with various travel service providers (e.g., for server(s) 116 to communicate with server(s) 114 and/or to access data relating to travel service providers 174-176 via app-to-app interaction on device 110 and/or device 141), may store a name, username, address, billing and account information, and/or other data regarding traveler 140, and so forth. In one example, server(s) 116 may obtain and store location data, speed data, orientation data, or other biometric data of traveler 140 from device 110 and/or from device 141.

In the example of FIG. 1, server(s) 116 may be in communication with devices 190 and 191 at a check-in counter 131 of the airport. Devices 190 and 191 may be used by airline agents to check-in passengers and/baggage, to make or change reservations for flights, and so forth. In one example, there may be a queue 181 of travelers, e.g., a check-in line for the check-in counter 131. In accordance with the present disclosure travelers, such as traveler 140, may be prioritized at the queue 181 depending upon the on-time statues of such travelers. For instance, a priority check-in may be provided for certain level(s) of frequent fliers, certain classes of tickets (e.g., first class, business class, coach, etc.), etc. However, as described in greater detail below, in one example, server(s) 116 may communicate with device 191 to add a traveler name to a list of travelers eligible for priority check-in. Similarly, server(s) 116 may be in communication with device 148 at an airport gate (e.g., Gate A) where an agent 145 of the airline may manage a boarding and departure of a particular aircraft. Device 148 may provide various visualizations of statuses, locations, and other information regarding travelers who are scheduled for the particular flight aboard the particular aircraft, such as a map of current traveler locations, a list of travelers anticipated to be late for the scheduled departure, and so forth.

In one example, AS 104 may comprise a network-based server (or servers) providing a network-based infrastructure for a transportation carrier server/system. In this regard, AS 104 may comprise the same or similar components as server(s) 116 and may provide the same or similar functions, or at least a portion thereof. For instance, an operator of network 102 may provide the transportation carrier server/system, supported via AS 104 in accordance with the present disclosure (e.g., in addition to telecommunication services such as TV, phone, internet access, etc., as described above). Accordingly, DB(s) 106 may be the same as or similar to DB(s) 117 and may store the same or similar information. Thus, although the following examples are described primarily in connection with server(s) 116, it should be understood that the descriptions may equally apply to AS 104.

In an illustrative example, traveler 140 may have a reservation and may be commencing a flight having a scheduled departure time from Gate A at the airport as illustrated in FIG. 1. In order to reach Gate A, the traveler 140 may need to first check-in at the check-in counter 131, which may have a queue 181 of other travelers also waiting to check-in. Next, traveler 140 may need to pass security checkpoint 133, which may also have a queue 183 of other travelers waiting to pass the security checkpoint. The traveler 140 may optionally place an order for a coffee or other beverages at coffee shop 132, which may also have a queue 182 of travelers (or other customers) waiting for orders to be fulfilled. In one example, server(s) 116 may, on an ongoing basis, calculate the anticipated arrival time of traveler 140 at the gate A, and may determine whether the traveler 140 is anticipated to be on-time (or early) or late for the scheduled departure time. For example, server(s) 116 may obtain location data of user 140 from device 110 or device 141, speed data (which in one example may alternatively or additionally be calculated by server(s) 116 from the location data), orientation data (e.g., which direction the traveler 140 is facing), and optionally may obtain biometric data of user 140. In one example, a position of traveler 140 in a queue, such as queue 181 may also be determined. For example, the airline may have a quick response (QR) code or similar scanner for travelers to enter the queue 181. If traveler 140 has a pending beverage order, for instance, server(s) 116 may obtain notification of the pending order (and in one example a position in queue 182) from one of server(s) 114 (e.g., a beverage vendor system associated with travel service provider 176), from device 192, and/or from one of devices 110 or 141. In general, server(s) 116 may obtain data regarding queue lengths and/or times for queue processing from an airline's own systems (e.g., from check-in counter 131) and one or more additional systems of various travel service providers. As such, server(s) 116 may possess information on lengths and/or processing times of queues 181-183, for example. Server(s) 116 may further possess data regarding distances within an airport, such as a distance from check-in counter 131 to Gate A. Thus, server(s) 116 may calculate an estimated arrival time at the gate for traveler 140 using any or all of such information, e.g., estimating walking speed based upon recent walking speed(s), determining a time to cover the walking distance from a current location to the gate, determining times to transit one or more queues, and combining these calculations to determine an overall time to reach Gate A. In various examples, server(s) 116 may further obtain or possess information regarding average times for travelers to move between various points, where walking speed is not necessarily indicative of how long the movement will take. For instance, various terminals include escalators, conveyers, inter-terminal trains, monorails, shuttle buses, and so on. Thus, server(s) 116 may alternatively or additionally estimate time to reach Gate A based upon averages of other travelers' movements, and/or based upon averages of other travelers movements scaled based upon a typical walking speed of traveler 140 as compared to walking speeds of other travelers (for instance, a scaling factor may be applied based upon traveler 140 being a relatively faster or slower walker as compared to an average traveler based upon the available data), and so on.

For illustrative purposes, it may be assumed that server(s) 116 calculate that traveler 140 will not be on-time for boarding the plane at Gate A at the designated time. In response, server(s) 116 may take any one or more remedial actions. For instance, server(s) 116 may send an alert to device 110 and/or device 141 indicating that the traveler 140 is anticipated to be late to Gate A (e.g., anticipated to not be at Gate A at the designated time of boarding, or anticipated to be at Gate A after the boarding time has expired where additional boarding of passengers will not be allowed). In one example, server(s) 116 may transmit a notification to a travel service provider system (e.g., one or more of server(s) 114) associated with at least one queue to be transited by traveler 140 (e.g., one of queues 182 or 183) requesting a prioritized processing for traveler 140. In one example, server(s) 116 may obtain responses from such travel service provider systems confirming or denying the request(s). Similarly, server(s) 116 may contact one or more devices of the airline to similarly instruct or request prioritized processing of traveler 140 (e.g., requesting via devices 190 and/or 191 that traveler 140 be expedited through check-in counter 131). For instance, an agent at device 191 may see traveler 140 added to a list of travelers who are permitted to obtain priority check-in and may process traveler 140 accordingly. In addition, a notification to traveler 140 that traveler 140 is anticipated to be late may include an instruction to proceed to “priority” check-in instead of “regular” check-in.

Alternatively, or in addition, server(s) 116 may provide a digital token to device 110 and/or device 141 that is presentable to obtain a prioritized transit of the at least one queue (and/or one or more digital tokens to obtain prioritized transit of multiple queues). Each digital token may comprise a QR code or the like that may be presented on a screen of device 110, a code that may be presented via a short-range/peer-to-peer wireless signal from device 110 or device 141 to a corresponding device associated with one of queues 181-183, or the like. In one example, the digital token(s) may facilitate automated access, such as via device 194 (e.g., an automated gate or turnstile). For instance, the device 194 may be provided with an identification of traveler 140 and/or of the digital token. Thus, when presented with the digital token, device 194 may permit user 140 to pass. The digital token(s) may be obtained by server(s) 116 from travel service provider system(s), e.g., server(s) 114, and provided to device 110 and/or device 141, or may be generated by server(s) 116, provided to device 110 and/or device 141, and notified to server(s) 114. In turn, server(s) 114 may provide notification(s) to devices 192, 193, 194, or the like, such that traveler 140 may present the digital token(s) in-person and obtain the requested expedited processing. In another example, the digital token(s) may be provided to server(s) 114 by app-to-app interactions on device 110 or device 141 and then subsequent transmission to corresponding travel service provider system(s) of server(s) 114. In another example, a digital token may comprise a hardware identifier of device 110 and/or device 141 (e.g., a media access control (MAC) identifier ID, an international mobile subscriber identity (IMSI) number, or the like). In other words, travel service provider system(s) may be notified of a particular traveler to be prioritized, where such traveler can be identified by wireless transmission and detection of a unique device identifier.

In one example, server(s) 116 may change the designated time of departure (and/or the designated time(s) of boarding, e.g., for one or more zones of the aircraft). In one example, server(s) 116 may establish at least one communication session between agent 145 (via device 148) and traveler 140 (via device 110 and/or device 141). For instance, agent 145 may be permitted with the appropriate authorization to speak with traveler 140 to inquire as to the traveler 140's ability to move faster, to confirm instructions to proceed to priority check-in, to provide assistance if traveler 140 is unsure how to use and present a digital token at security checkpoint 133, to provide instructions as to how to most efficiently proceed from a current location of user 140 to Gate A, and so forth.

As noted above, in one example, travelers may accumulate and expend credits in order to facilitate expedited processing at one or more queues. For instance, travelers may give consent to be jumped in a queue, e.g., in exchange for a “credit.” In one example, travelers or other customers in a queue who may be jumped by a late traveler (such as traveler 140) may indicate consent on an ongoing basis. Alternatively, or in addition, travel service provider devices or systems (e.g., server(s) 114) may communicate with travelers or other customers in queue to obtain consent in response to particular requests from server(s) 116. The credits may be provided and recorded in accounts/records (e.g., in DB(s) 117 and/or DB(s) 115) for the other travelers/customers. In one example, credits may be deducted from traveler 140. In another example, traveler 140 may be obligated to assume additional charges for the flight in correspondence to the amount of credits used (e.g., per a contract of carriage, tariff or the like). In one example, if there is a person ahead in-queue who is not willing to be jumped, then the traveler's priority will be advanced as far in the queue as possible up to the non-willing person. In another example, credit may be used in the future from past credit earnings such that traveler 140 may earn a right to jump even an unwilling person, e.g., a willing person who yielded to the traveler 140 may earn credits for such action that will in turn allow such willing person to use the earned credits for his or her future need to jump ahead of other travelers.

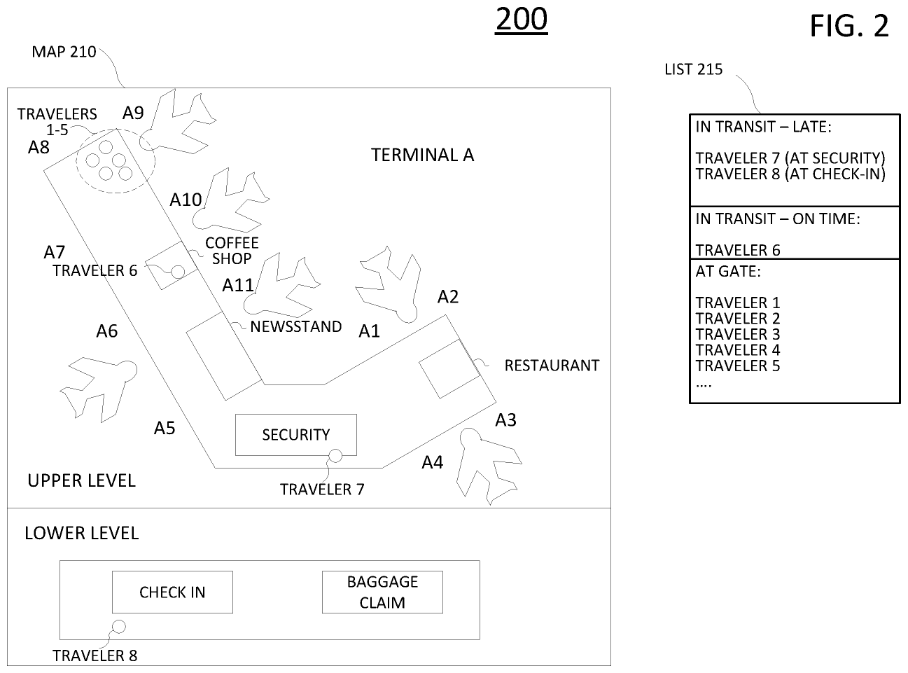

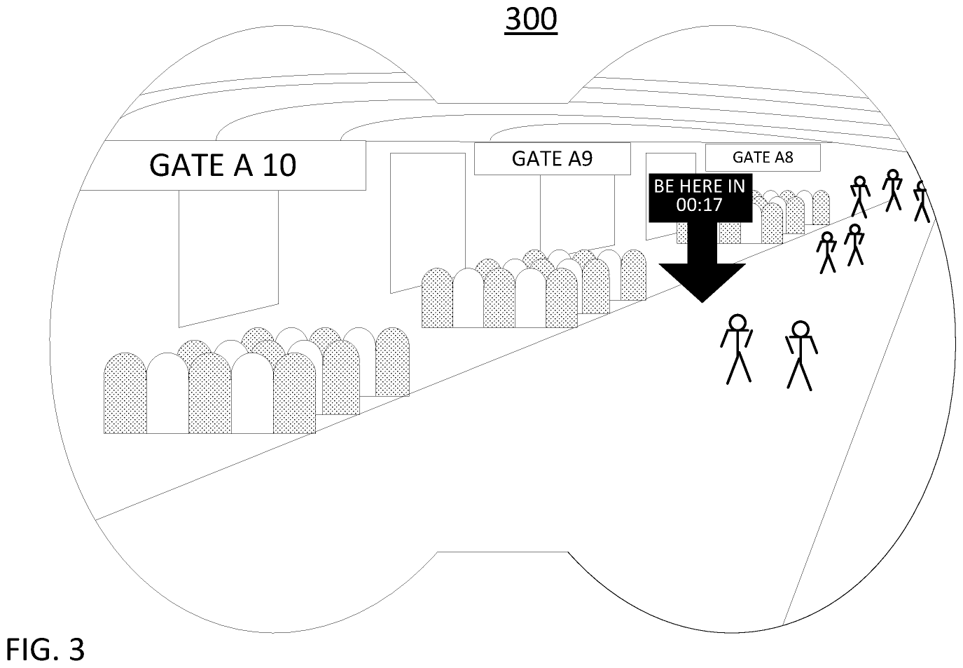

It should be noted that on an ongoing basis or on command of agent 145, device 148 may present a list of travelers having reservations to board the aircraft, may present a list of travelers anticipated to be late (e.g., including at least traveler 140), may present a map of the airport with corresponding current locations of such travelers, and so on. For instance, server(s) 116 may track traveler locations as noted above, and may provide on-time status information and location information to device 148 for display. An example interface for presenting traveler information to an agent of transportation carrier is illustrated in FIG. 2 and described in greater detail below. In one example, server(s) 116 may provide augmented reality (AR) assistance to traveler 140 to reach Gate A on-time (or to at least increase the likelihood of doing so). For instance, FIG. 3 illustrates an example AR interface that may be provided for traveler 140 to assist in reaching a point of departure.

It should be noted that the foregoing is just one illustrative example of how examples of the present disclosure for performing at least one remedial action in response to determining that an arrival time of at least one of a plurality of travelers is after a designated time of readiness for traveling aboard a vehicle in accordance with location data of devices of the plurality of travelers and timing data of at least one queue and/or for obtaining and presenting a digital token to at least one service provider system associated with at least one queue to obtain a prioritized transit of the at least one queue may operate. Thus, it should be noted that in other, further, and different examples, aspects described above with respect to server 116 may alternatively or additionally be provided by AS 104. In addition to the foregoing, various other features of the present disclosure may be provided via the system 100. As just one example, traveler 140 may utilize a transportation carrier app on device 110 or device 141 to contact server(s) 116 and request a prediction of whether traveler 140 may make a stop for food or coffee, to stop at a newsstand or other shops, to use a restroom, and so forth (e.g., while still remaining on-time), and/or to obtain confirmation to make such a stop (for example, without penalty or with reduced penalty from the transportation carrier if the traveler 140 is actually late as a result of the additional stop, e.g., if such stop is no longer than X minutes, for example). In another example, instead of requesting expedited processing for traveler 140, server(s) 116 may automatically cancel beverage orders, food orders, or the like (e.g., those that have not yet been prepared/fulfilled). For instance, the server(s) 116 may unilaterally determine that traveler 140 will be late (or too late) to the scheduled departure if traveler 140 continues to wait for a coffee, even if expedited. Thus, server(s) 116 may entirely cancel the order with the user's prior consent (e.g., with penalty, partial refund, etc. as arranged with the coffee shop or other travel service providers, and in one example with prior consent from traveler 140 to permit such actions for defined occurrences of circumstances, e.g., via a user profile with preselected authorizations for different encountered scenarios or situations, where traveler 140 may be deemed at risk of missing a flight, for instance).

It should also be noted that the system 100 has been simplified. Thus, the system 100 may be implemented in a different form than that which is illustrated in FIG. 1, or may be expanded by including additional endpoint devices, access networks, network elements, application servers, etc. without altering the scope of the present disclosure. In addition, system 100 may be altered to omit various elements, substitute elements for devices that perform the same or similar functions, combine elements that are illustrated as separate devices, and/or implement network elements as functions that are spread across several devices that operate collectively as the respective network elements. For example, the system 100 may include other network elements (not shown) such as border elements, routers, switches, policy servers, security devices, gateways, a content distribution network (CDN) and the like. For example, portions of network 102 and/or access networks 120 and 122 may comprise a content distribution network (CDN) having ingest servers, edge servers, and the like. Similarly, although only two access networks 120 and 122 are shown, in other examples, access networks 120 and/or 122 may each comprise a plurality of different access networks that may interface with network 102 independently or in a chained manner. For example, server(s) 114 and server(s) 116 may reach network 102 via different access networks, and so forth. Thus, these and other modifications are all contemplated within the scope of the present disclosure.

To further illustrate aspects of the present disclosure, FIG. 2 depicts an example interface 200 providing traveler information to an agent of a transportation service provider. For illustrative purposes, there may be nine travelers 1-9 scheduled to travel aboard a flight departing from Gate A9 of Terminal A. As illustrated in FIG. 2, interface 200 may include a map 210 of Terminal A, with locations of travelers 1-9 indicated. For instance, travelers 1-8 may each have consented to have locations tracked via respective mobile computing devices by a transportation carrier system (e.g., one or more transportation carrier servers). In addition, one or more of travelers 1-8 may further have a transportation carrier app installed on respective mobile computing devices in connection with examples of the present disclosure (e.g., to obtain location information, biometric data, and so forth, to communicate alerts, warnings, directions, AR content, etc. to the travelers, and so on). In addition, interface 200 may include a list 215 providing additional data on the statuses of travelers 1-8. In the example of FIG. 2, the list 215 may be organized by travelers who are anticipated to be “late,” “on-time,” and those who are already tracked to be present at the designated departure gate, Gate A9. However, in other examples, list 215 may be organized in a different manner. For instance, a gate agent may rearrange the list 215 to be organized in alphabetical order, to be organized by zone, etc. In such case, the on-time status of travelers 1-8 may be indicated next to respective traveler names, for example.

In one example, travelers anticipated to be late may be highlighted on the map in various ways, such as color highlighting, blinking icon or other indicators, bold or larger font/text, a dialog box near a traveler's location, etc. Although a transportation carrier server may automatically determine whether and when to obtain prioritized processing of travelers at various queues as described herein, in one example, an agent of the transportation carrier may also initiate such requests for one or more travelers. For instance, an agent via interface 200 may select a traveler name from list 215 (e.g., by clicking with a pointer, tapping on a touch screen, or the like), which may access a drop down list or menu (not shown) of options including the current ability to request priority processing via one or more queues, such as at an expedited check-in, an expedited security checkpoint line, a an expedited process to be implemented at a coffee shop, or a restaurant, etc. Such a menu may also include an option to initiate a two-way conversation between an agent using a device presenting the interface 200 and a mobile computing device of a traveler, e.g., as described above. Similarly, the agent may select a traveler by clicking or tapping an icon representing the traveler's location on the map 210, which may call up a dialog box with additional information about the traveler, the traveler's status, options to prioritize the traveler, to communicate with the traveler, and so forth.

To further aid in understanding the present disclosure, FIG. 3 illustrates and example interface 300, e.g., an AR interface, that may be presented to a traveler in connection with reaching a point of departure on time. The interface 300 may be a combination of visible real-world imagery and overlay content projected via AR glasses. In the present example, a traveler may be along a corridor having three gates, one of which is where the traveler is expected to be waiting to board a flight at a scheduled boarding time, Gate A9. In the example of FIG. 3, the traveler may already be within sight of Gate A9. The interface 300 may present a marker indicating “be here in 00:17.” In other words, the traveler should be at Gate A9 within the next 17 seconds to be considered on time. The marker may assist the traveler is seeing the location of Gate A9 stand out from the rest of the surroundings. It should be noted that similar markers may be provided to the traveler at various other points (e.g., “waypoints”) along a route through an airport before arriving at or near the assigned gate, Gate A9. For instance, a marker may be displayed in the interface 300 so as to appear at the end of the corridor with an arrow pointing to the left and/or words “turn left here.” Similarly, a marker may be presented in the interface 300 so as to appear at a security checkpoint with an arrow and/or words “get in line here” or “present priority QR code here,” and so forth. In one example, a transportation carrier server/system (e.g., server(s) 116 of FIG. 1) may pre-map an airport or other transit centers so as to obtain a database of AR markers in the environment (some or all of which may also be used as waypoints for presenting visual data to the traveler). A traveler's AR device may then stream images captured from an external facing camera to the transportation carrier system to match visual imagery to available AR markers (and in one example, the determination being assisted by location data of the AR device that may also be made available to the transportation carrier system). The transportation carrier system may respond to the AR device with AR content and the location(s) within interface 300 in which to present such content based on any detected AR markers. Alternatively, AR markers may be provided to the AR device, which may similarly detect such markers in visual images obtained via the AR device, and which may place AR content in the correct visual locations within interface 300 accordingly.

FIG. 4 illustrates a flowchart of an example method 400 for performing at least one remedial action in response to determining that an arrival time of at least one of a plurality of travelers is after a designated time of readiness for traveling aboard a vehicle in accordance with location data of devices of the plurality of travelers and timing data of at least one queue. In one example, the method 400 is performed by any one or more components of FIG. 1, such as server(s) 116 (e.g., a transportation carrier system) or any one or more components thereof, or by server(s) 116 in conjunction with other devices and/or components of system 100 of FIG. 1. In one example, the steps, functions, or operations of method 400 may be performed by a computing device or processing system, such as computing system 600 and/or hardware processor element 602 as described in connection with FIG. 6 below. For instance, the computing system 600 may represent any one or more components of the system 100 that is/are configured to perform the steps, functions and/or operations of the method 400 (e.g., server(s) 116). Similarly, in one example, the steps, functions, or operations of the method 400 may be performed by a processing system comprising one or more computing devices collectively configured to perform various steps, functions, and/or operations of the method 400. For instance, multiple instances of the computing system 600 may collectively function as a processing system. For illustrative purposes, the method 400 is described in greater detail below in connection with an example performed by a processing system. The method 400 begins in step 405 and proceeds to step 410.

At step 410, the processing system may obtain traveler data comprising at least location data of a plurality of devices of a plurality of travelers, the plurality of travelers having reservations to travel aboard a vehicle of a transportation service provider from a point of departure at a designated time of readiness. In one example, the traveler data may further comprise pacing data of the plurality of travelers (e.g., traveler walking speeds, which may be recent walking speeds and/or average walking speeds over longer periods of time for which the travelers walking speeds have been tracked, and which may also include directions of movement).

At step 420, the processing system obtains timing data of at least one queue from at least one service provider system associated with the at least one queue, wherein at least one of the plurality of travelers is to traverse the at least one queue to arrive at the point of departure. For instance, the at least one queue may comprise a security checkpoint (e.g., TSA, customs, immigration, etc.), a traveler check-in line of the transportation service provider, a service line for a food or beverage vendor, and so forth. The timing data of the at least one queue may be obtained from one or more service provider systems associated with the at least one queue, or may be obtained from traveler devices, e.g., where queue timing data may be shared by a travel service provider app with an app associated with a transportation service provider (e.g., the transportation service provider operating the processing system performing the method 400).

At step 430, the processing system calculates arrival times of the plurality of travelers based upon the traveler data comprising at least the location data of the plurality of devices of the plurality of travelers and based upon the timing data of the at least one queue. In one example, the calculating the arrival times of the plurality of travelers may be further based upon the traveler data comprising the pacing data of the plurality of travelers. For example, the calculating of the arrival times may use any or all of such information, e.g., estimating walking speed based upon recent walking speed(s), determining time to cover the walking distance from a current location to the gate, determining times to transit one or more queues, and combining these calculations to determine an overall time to reach the designated point of departure. In various examples, the processing system may further obtain or possess information regarding average times for travelers to move between various points, where walking speed is not necessarily indicative of how long the movement will take. For instance, various airports, train stations, and so on include escalators, conveyers, inter-terminal trains, monorails, shuttle buses, or the like. Thus, the processing system may alternatively or additionally estimate time to reach the designated point of departure based upon averages of other travelers' movements, and/or based upon averages of other travelers' movements scaled based upon a typical walking speed of a given traveler as compared to walking speeds of other travelers, and so on.

In one example, step 430 may include calculating on-time statuses of the plurality of travelers in relation to at least one waypoint, where the on-time statuses are calculated based upon at least the location data of the plurality of devices of the plurality of travelers, the location of the at least one waypoint, and pacing or speed data of the plurality of travelers. For instance, the processing system may calculate that all travelers should be past waypoint X by 7:30 PM in order to be on-time for departure at the designated location at 7:45 PM. In one example, the on-time statuses are further calculated based upon the timing data of the at least one queue.

At optional step 440, the processing system may generate a map of locations of the plurality of travelers based upon the location data of the plurality of devices of the plurality of travelers. For instance, the map may be the same or similar to the map 210 of FIG. 2.

At optional step 450, the processing system may present information associated with the arrival times of the plurality of travelers via at least one device of at least one agent of the transportation service provider, where the information is presented via at least one of the map of locations of the plurality of travelers (which, in one example, may be generated at optional step 440) or at least one list of the plurality of travelers. For instance, a list may present the plurality of travelers in an order of the arrival times of the plurality of travelers. In one example, the map and/or list may be the same or similar to map 210 and list 215 of FIG. 2. In one example, the map may include indicators of the directions of movement of the plurality of travelers (e.g., arrows pointing in the current or most recent directions of movement).

At step 460, the processing system determines that an arrival time of at least one of the plurality of travelers is after the designated time of readiness.

At step 470, the processing system performs at least one remedial action in response to the determining that the arrival time of the at least one of the plurality of travelers is after the designated time of readiness. For instance, the at least one remedial action may comprise sending an alert to at least one device of the at least one of the plurality of travelers indicating that the at least one of the plurality of travelers is anticipated to not be at the point of departure at the designated time of readiness. To illustrate, the alert may comprise data enabling the at least one device of the at least one of the plurality of travelers who is anticipated to not be at the point of departure at the designated time of readiness to present at least one of an audio indicator, a visual indicator, or a haptic indicator (e.g., vibration of the at least one device, or the like) of an on-time status of a pace of the at least one of the plurality of travelers in relation to at least one waypoint en route to the point of departure, such as “speeding up to the departure gate is required,” “you are on-time at your current pace,” or the like. In one example, the on-time status may be presented as the visual indicator via an AR application operating on the at least one device of the at least one of the plurality of travelers who is anticipated to not be at the point of departure at the designated time of readiness (or in some instances such visual indicators are also presented to those individuals who are deemed to be on time if such individuals want such AR assistance), where the visual indicator may be projected on or near the at least one waypoint within a field of view of the at least one of the plurality of travelers. In one example, the visual indicator may include a countdown timer indicating a time remaining or a time elapsed in relation to a time of reaching the at least one waypoint for a calculated on-time arrival at the point of departure. The visual indicator can also be highlighted, color coded, red, yellow, green, etc., may be blinking or otherwise drawing attention, and/or can include suggestion/instruction to pick up the pace, and may further include directions such as “turn left here,” “go straight ahead,” and so forth. Similarly, in one example, an audio indicator may further include audio directions to navigate a path from a traveler location to the point of departure. In addition, a haptic indicator may also include an indication of the correct direction of movement, e.g., a “nudge” in the proper direction.

In one example, the at least one remedial action may comprise providing a digital token to at least one device of the at least one of the plurality of travelers (e.g., where the digital token is presentable via the at least one device to obtain a prioritized transit of the at least one queue for the at least one of the plurality of travelers who is anticipated to not be at the point of departure at the designated time of readiness), and/or transmitting a notification to the at least one service provider system associated with the at least one queue requesting a prioritized transit of the at least one queue for the at least one of the plurality of travelers who is anticipated to not be at the point of departure at the designated time of readiness. Alternatively, or in addition, the at least one remedial action may comprise changing the designated time of readiness to a later time and transmitting a notification of the later time to the plurality of device of the plurality of travelers, establishing at least one communication session between at least one device of the at least one of the plurality of travelers who is anticipated to not be at the point of departure at the designated time of readiness and a device of the transportation service provider, and so forth.

Following step 470, the method 400 proceeds to step 495. At step 495 the method 400 ends.

It should be noted that the method 400 may be expanded to include additional steps, or may be modified to replace steps with different steps, to combine steps, to omit steps, to perform steps in a different order, and so forth. For instance, in one example the processing system may repeat one or more steps of the method 400, such as steps 410-440 or steps 410-460 until it is determined that at least one traveler will not be on time, steps 410-470 for additional flights, voyages, or the like, and so on. In one example, step optional steps 440 and 450 may be performed after step 470. In one example, the timing data of the at least one queue may include an indication that a business is closed. Thus, for example, even if a user typically stops for a coffee, if the coffee shop is closed, the time to transit the queue may be estimated as zero (or omitted from the calculation at step 430 entirely). In one example, the method 400 may include determining a time for another type of stop, such as picking up a child, having a business meeting, stopping to use a restroom, or other engagement that may be included in the calculation of step 430. In one example, the method 400 may be expanded to include obtaining an inquiry from a traveler of the plurality of travelers regarding whether a stop of a certain duration is acceptable while maintaining an on-time arrival or early arrival at the point of departure, obtaining timing data of the stop, recalculating an arrival time of the traveler based upon the traveler data, the timing data of the at least one queue, and timing data of the stop, and transmitting a response indicating whether the stop is acceptable, in accordance with the arrival time that is recalculated. In one example, the method 400 may further include a step of determining whether the arrival time of the traveler that is recalculated is after the designated time of readiness (e.g., prior to transmitting a response indicating whether the stop is acceptable). In one example, the method 400 may include obtaining biometric data of one or more travelers, wherein the arrival time(s) of the one or more travelers may be calculated further based on the biometric data. For instance, if a traveler is detected to have a heart rate indicative of exertion, the arrival time may be calculated to be earlier than would otherwise be calculated.

In one example, the calculating of on-time statuses may be a separate step from step 430. In one example, the method 400 may further include calculating a credit cost of at least one device of the at least one of the plurality of travelers to use the digital token to obtain prioritized processing via the at least one queue. In one example, the method 400 may include obtaining consents from devices of other travelers and/or customers in the queue(s), providing credits to such devices and/or accounts associated with such devices, and so forth. In one example, the method 400 may be modified to alternatively or additionally include any aspects of the present disclosure described herein and/or illustrated in connection with any of FIGS. 1-6. Thus, these and other modifications are all contemplated within the scope of the present disclosure.

FIG. 5 illustrates a flowchart of an example method 500 for obtaining and presenting a digital token to at least one service provider system associated with at least one queue to obtain a prioritized transit of the at least one queue. In one example, the method 500 is performed locally by an endpoint device/user device, such as device 110 or device 141 of FIG. 1, or any one or more components thereof, by devices 110 and 141 in coordination with each other and/or in conjunction with other devices and/or components of system 100 of FIG. 1. In one example, the steps, functions, or operations of method 500 may be performed by a computing device or processing system, such as computing system 600 and/or hardware processor element 602 as described in connection with FIG. 6 below. For instance, the computing system 600 may represent any one or more components of the system 100 that is/are configured to perform the steps, functions and/or operations of the method 500 (e.g., device 110 and/or device 141). Similarly, in one example, the steps, functions, or operations of the method 500 may be performed by a processing system comprising one or more computing devices collectively configured to perform various steps, functions, and/or operations of the method 500. For instance, multiple instances of the computing system 600 may collectively function as a processing system. For illustrative purposes, the method 500 is described in greater detail below in connection with an example performed by a processing system. The method 500 begins in step 505 and proceeds to step 510.

At step 510, the processing system (e.g., of an apparatus comprising a mobile computing device of a user) provides location data of the apparatus to a transportation service provider system, wherein the apparatus is associated with a traveler having a reservation to travel aboard a vehicle of the transportation service provider from a point of departure at a designated time of readiness, wherein the traveler is to traverse the at least one queue to arrive at the point of departure. The at least one queue may comprise, for instance: a security checkpoint, a traveler check-in line of the transportation service provider, a service line for a food or beverage vendor, and so forth.

At optional step 520, the processing system may obtain and transmit an inquiry from the traveler to the transportation service provider system regarding whether a stop is acceptable while maintaining an on-time arrival or early arrival at the point of departure.

At optional step 530, the processing system may obtain and present a response from the transportation service provider system indicating whether the stop is acceptable.

At step 540, the processing system obtains an alert from the transportation service provider system indicating that the traveler is anticipated to not be at the point of departure at the designated time of readiness. In one example, the alert may include an on-time status of a pace of the traveler in relation to at least one waypoint en route to the point of departure.

At step 550, the processing system presents the alert to the traveler. For instance, in one example, step 550 may include presenting at least one of an audio indicator or a visual indicator of the on-time status of the pace of the traveler in relation to the at least one waypoint. In one example, the on-time status may be presented as the visual indicator via an augmented reality application. For instance, the visual indicator may be projected on or near the at least one waypoint within a field of view of the traveler. In one example, the visual indicator includes a countdown timer indicating a time remaining or a time elapsed in relation to a time of reaching the at least one waypoint for a calculated on-time arrival at the point of departure. In one example, the audio indicator may further include audio directions to navigate a path from a traveler location to the point of departure.

At optional step 560, the processing system may establish, in response to the alert, a communication session between the processing system and a device of the transportation service provider, e.g., for a voice or text conversation between the traveler and an agent of the transportation service provider. For instance, the agent may inquire as to the traveler's ability to move faster, to confirm instructions to proceed to a priority line (e.g., at a check-in, security, etc.), to provide assistance if traveler is unsure how to use and present a digital token, to provide instructions as to how to most efficiently proceed from a current location to the designated point of departure, and so forth. It should be noted that in various examples the voice conversation may include a video call, an augmented reality/mixed reality call, a voice-only call, and so forth.

At step 570, the processing system obtains a digital token from the transportation service provider system, wherein the digital token is presentable via the apparatus to obtain a prioritized transit of the at least one queue for the traveler. In one example, step 570 may further include obtaining a notification of a credit cost incurred by the traveler to obtain the prioritized transit of the at least one queue. For instance, in one example, this may be imposed on the traveler involuntarily by the transportation service provider system, or by prior consent of the traveler to incur a credit cost in certain circumstances (such as set forth in contract of carriage or tariff).

At step 580, the processing system presents the digital token to at least one service provider system associated with the at least one queue to obtain the prioritized transit of the at least one queue for the traveler. In one example, the digital token may be presented as a visual code that is scanned by a component of the at least one service provider system. In another example, the digital token may be transmitted via a near-field communication by the processing system to the at least one service provider system.

Following step 580, the method 500 proceeds to step 595. At step 595 the method 500 ends.

It should be noted that the method 500 may be expanded to include additional steps, or may be modified to replace steps with different steps, to combine steps, to omit steps, to perform steps in a different order, and so forth. For instance, in one example the processing system may repeat one or more steps of the method 500, such as steps 510-530 for multiple stops before a current departure, steps 510-570 for additional trips, and so on. In one example, steps 570 and/or 580 may be optional steps. For instance, in one example, a device identifier may be used as a digital token such that a digital token is not necessarily received from the transportation service provider system. In one example, the method 500 may be modified to alternatively or additionally include any aspects of the present disclosure described herein and/or illustrated in connection with any of FIGS. 1-6. Thus, these and other modifications are all contemplated within the scope of the present disclosure.

In addition, although not expressly specified above, one or more steps of the method 400 or the method 500 may include a storing, displaying and/or outputting step as required for a particular application. In other words, any data, records, fields, and/or intermediate results discussed in the respective methods can be stored, displayed and/or outputted to another device as required for a particular application. Furthermore, operations, steps, or blocks in FIGS. 4 and 5 that recite a determining operation or involve a decision do not necessarily require that both branches of the determining operation be practiced. In other words, one of the branches of the determining operation can be deemed as an optional step. Furthermore, operations, steps or blocks of the above described method(s) can be combined, separated, and/or performed in a different order from that described above, without departing from the example embodiments of the present disclosure.

FIG. 6 depicts a high-level block diagram of a computing system 600 (e.g., a computing device or processing system) specifically programmed to perform the functions described herein. For example, any one or more components or devices illustrated in FIG. 1, or described in connection with FIGS. 2-5, may be implemented as the computing system 600. As depicted in FIG. 6, the computing system 600 comprises a hardware processor element 602 (e.g., comprising one or more hardware processors, which may include one or more microprocessor(s), one or more central processing units (CPUs), and/or the like, where the hardware processor element 602 may also represent one example of a “processing system” as referred to herein), a memory 604, (e.g., random access memory (RAM), read only memory (ROM), a disk drive, an optical drive, a magnetic drive, and/or a Universal Serial Bus (USB) drive), a module 605 for performing at least one remedial action in response to determining that an arrival time of at least one of a plurality of travelers is after a designated time of readiness for traveling aboard a vehicle in accordance with location data of devices of the plurality of travelers and timing data of at least one queue or for obtaining and presenting a digital token to at least one service provider system associated with at least one queue to obtain a prioritized transit of the at least one queue, and various input/output devices 606, e.g., a camera, a video camera, storage devices, including but not limited to, a tape drive, a floppy drive, a hard disk drive or a compact disk drive, a receiver, a transmitter, a speaker, a display, a speech synthesizer, an output port, and a user input device (such as a keyboard, a keypad, a mouse, and the like).

Although only one hardware processor element 602 is shown, the computing system 600 may employ a plurality of hardware processor elements. Furthermore, although only one computing device is shown in FIG. 6, if the method(s) as discussed above is implemented in a distributed or parallel manner for a particular illustrative example, e.g., the steps of the above method(s) or the entire method(s) are implemented across multiple or parallel computing devices, then the computing system 600 of FIG. 6 may represent each of those multiple or parallel computing devices. Furthermore, one or more hardware processor elements (e.g., hardware processor element 602) can be utilized in supporting a virtualized or shared computing environment. The virtualized computing environment may support one or more virtual machines which may be configured to operate as computers, servers, or other computing devices. In such virtualized virtual machines, hardware components such as hardware processors and computer-readable storage devices may be virtualized or logically represented. The hardware processor element 602 can also be configured or programmed to cause other devices to perform one or more operations as discussed above. In other words, the hardware processor element 602 may serve the function of a central controller directing other devices to perform the one or more operations as discussed above.

It should be noted that the present disclosure can be implemented in software and/or in a combination of software and hardware, e.g., using application specific integrated circuits (ASIC), a programmable logic array (PLA), including a field-programmable gate array (FPGA), or a state machine deployed on a hardware device, a computing device, or any other hardware equivalents, e.g., computer-readable instructions pertaining to the method(s) discussed above can be used to configure one or more hardware processor elements to perform the steps, functions and/or operations of the above disclosed method(s). In one example, instructions and data for the present module 605 for performing at least one remedial action in response to determining that an arrival time of at least one of a plurality of travelers is after a designated time of readiness for traveling aboard a vehicle in accordance with location data of devices of the plurality of travelers and timing data of at least one queue or for obtaining and presenting a digital token to at least one service provider system associated with at least one queue to obtain a prioritized transit of the at least one queue (e.g., a software program comprising computer-executable instructions) can be loaded into memory 604 and executed by hardware processor element 602 to implement the steps, functions or operations as discussed above in connection with the example method(s). Furthermore, when a hardware processor element executes instructions to perform operations, this could include the hardware processor element performing the operations directly and/or facilitating, directing, or cooperating with one or more additional hardware devices or components (e.g., a co-processor and the like) to perform the operations.

The processor (e.g., hardware processor element 602) executing the computer-readable instructions relating to the above described method(s) can be perceived as a programmed processor or a specialized processor. As such, the present module 605 for performing at least one remedial action in response to determining that an arrival time of at least one of a plurality of travelers is after a designated time of readiness for traveling aboard a vehicle in accordance with location data of devices of the plurality of travelers and timing data of at least one queue or for obtaining and presenting a digital token to at least one service provider system associated with at least one queue to obtain a prioritized transit of the at least one queue (including associated data structures) of the present disclosure can be stored on a tangible or physical (broadly non-transitory) computer-readable storage device or medium, e.g., volatile memory, non-volatile memory, ROM memory, RAM memory, magnetic or optical drive, device or diskette and the like. Furthermore, a “tangible” computer-readable storage device or medium may comprise a physical device, a hardware device, or a device that is discernible by the touch. More specifically, the computer-readable storage device or medium may comprise any physical devices that provide the ability to store information such as instructions and/or data to be accessed by a processor or a computing device such as a computer or an application server.

While various examples have been described above, it should be understood that they have been presented by way of example only, and not limitation. Thus, the breadth and scope of a preferred example should not be limited by any of the above-described examples, but should be defined only in accordance with the following claims and their equivalents.

1.-10. (canceled)

11. An apparatus comprising:
a processing system including at least one processor; and
a computer-readable medium storing instructions that, when executed by the processing system, cause the processing system to perform operations, the operations comprising:
providing location data of the apparatus to a transportation service provider system of a transportation service provider, wherein the apparatus is associated with a traveler having a reservation to travel aboard a vehicle of the transportation service provider from a point of departure at a designated time of readiness, wherein the traveler is to traverse at least one queue to arrive at the point of departure;
obtaining an alert from the transportation service provider system indicating that the traveler is anticipated to not be at the point of departure at the designated time of readiness;
presenting the alert to the traveler;
obtaining a digital token from the transportation service provider system, wherein the digital token is presentable via the apparatus to obtain a prioritized transit of the at least one queue for the traveler; and
presenting the digital token to at least one service provider system associated with the at least one queue to obtain the prioritized transit of the at least one queue for the traveler.

12. The apparatus of claim 11, wherein the digital token is presented as a visual code that is scanned by a component of the at least one service provider system associated with the at least one queue or is transmitted via a near-field communication from the apparatus to the at least one service provider system associated with the at least one queue.

13. The apparatus of claim 11, wherein the alert includes an on-time status of a pace of the traveler in relation to at least one waypoint en route to the point of departure, wherein the presenting the alert comprises presenting at least one of: an audio indicator, a visual indicator, or a haptic indicator of the on-time status of the pace of the traveler in relation to the at least one waypoint.

14. The apparatus of claim 13, wherein the on-time status is presented as the visual indicator via an augmented reality application wherein the visual indicator is projected on or near the at least one waypoint within a field of view of the traveler.

15. The apparatus of claim 14, wherein the visual indicator includes a countdown timer indicating a time remaining or a time elapsed in relation to a time of reaching the at least one waypoint for a calculated on-time arrival at the point of departure.

16. The apparatus of claim 13, wherein the audio indicator further includes audio directions to navigate a path from a traveler location to the point of departure.

17. The apparatus of claim 11, wherein the obtaining the digital token further comprises obtaining a notification of a credit cost incurred by the traveler to obtain the prioritized transit of the at least one queue.

18. The apparatus of claim 11, wherein the operations further comprise:
obtaining and transmitting an inquiry from the traveler to the transportation service provider system regarding whether a stop of a certain time is acceptable while maintaining an on-time arrival or early arrival at the point of departure; and
obtaining and presenting a response from the transportation service provider system indicating whether the stop is acceptable.

19. The apparatus of claim 11, wherein the operations further comprise:
establishing, in response to the alert, a communication session between the apparatus and a device of the transportation service provider for a voice or text conversation between the traveler and an agent of the transportation service provider.

20. The apparatus of claim 11, wherein the at least one queue comprises:
a security checkpoint queue;
a traveler check-in line queue of the transportation service provider; or
a service line queue for a food or beverage vendor.

21. A non-transitory computer-readable medium storing instructions that, when executed by a processing system including at least one processor deployed in an apparatus, cause the processing system to perform operations, the operations comprising:
providing location data of the apparatus to a transportation service provider system of a transportation service provider, wherein the apparatus is associated with a traveler having a reservation to travel aboard a vehicle of the transportation service provider from a point of departure at a designated time of readiness, wherein the traveler is to traverse at least one queue to arrive at the point of departure;
obtaining an alert from the transportation service provider system indicating that the traveler is anticipated to not be at the point of departure at the designated time of readiness;
presenting the alert to the traveler;
obtaining a digital token from the transportation service provider system, wherein the digital token is presentable via the apparatus to obtain a prioritized transit of the at least one queue for the traveler; and
presenting the digital token to at least one service provider system associated with the at least one queue to obtain the prioritized transit of the at least one queue for the traveler.

22. The non-transitory computer-readable medium of claim 21, wherein the digital token is presented as a visual code that is scanned by a component of the at least one service provider system associated with the at least one queue or is transmitted via a near-field communication from the apparatus to the at least one service provider system associated with the at least one queue.

23. The non-transitory computer-readable medium of claim 21, wherein the alert includes an on-time status of a pace of the traveler in relation to at least one waypoint en route to the point of departure, wherein the presenting the alert comprises presenting at least one of: an audio indicator, a visual indicator, or a haptic indicator of the on-time status of the pace of the traveler in relation to the at least one waypoint.

24. The non-transitory computer-readable medium of claim 23, wherein the on-time status is presented as the visual indicator via an augmented reality application wherein the visual indicator is projected on or near the at least one waypoint within a field of view of the traveler.

25. The non-transitory computer-readable medium of claim 24, wherein the visual indicator includes a countdown timer indicating a time remaining or a time elapsed in relation to a time of reaching the at least one waypoint for a calculated on-time arrival at the point of departure.

26. The non-transitory computer-readable medium of claim 23, wherein the audio indicator further includes audio directions to navigate a path from a traveler location to the point of departure.

27. The non-transitory computer-readable medium of claim 21, wherein the obtaining the digital token further comprises obtaining a notification of a credit cost incurred by the traveler to obtain the prioritized transit of the at least one queue.

28. The non-transitory computer-readable medium of claim 21, wherein the operations further comprise:
obtaining and transmitting an inquiry from the traveler to the transportation service provider system regarding whether a stop of a certain time is acceptable while maintaining an on-time arrival or early arrival at the point of departure; and
obtaining and presenting a response from the transportation service provider system indicating whether the stop is acceptable.

29. The non-transitory computer-readable medium of claim 21, wherein the operations further comprise:
establishing, in response to the alert, a communication session between the apparatus and a device of the transportation service provider for a voice or text conversation between the traveler and an agent of the transportation service provider.

30. A method comprising:
providing, by a processing system including at least one processor deployed in an apparatus, location data of the apparatus to a transportation service provider system of a transportation service provider, wherein the apparatus is associated with a traveler having a reservation to travel aboard a vehicle of the transportation service provider from a point of departure at a designated time of readiness, wherein the traveler is to traverse at least one queue to arrive at the point of departure;
obtaining, by the processing system, an alert from the transportation service provider system indicating that the traveler is anticipated to not be at the point of departure at the designated time of readiness;
presenting, by the processing system, the alert to the traveler;
obtaining, by the processing system, a digital token from the transportation service provider system, wherein the digital token is presentable via the apparatus to obtain a prioritized transit of the at least one queue for the traveler; and
presenting, by the processing system, the digital token to at least one service provider system associated with the at least one queue to obtain the prioritized transit of the at least one queue for the traveler.
